(19) United States
(12) Patent Application Publication
(10) Pub. No.: US 2018/0329988 A1
(43) Pub. Date: Nov. 15, 2018

(54) METHOD AND SYSTEM FOR A CARD BASED ADVANCED SOCIAL PRODUCTIVITY PLATFORM

(71) Applicant: RAMAKRISHNAN RATHINAM, KATY, TX (US)

(72) Inventor: RAMAKRISHNAN RATHINAM, KATY, TX (US)

(21) Appl. No.: 15/876,813

(22) Filed: Jan. 22, 2018

Related U.S. Application Data
(60) Provisional application No. 62/448,769, filed on Jan. 20, 2017.

(51) Int. Cl. G06F 17/30; G06Q 10/06; G06F 17/24

(52) U.S. Cl. CPC G06F 17/30702; G06F 17/248; G06Q 10/06311; G06F 17/30867

(57) ABSTRACT

A method for improving a project including registering a user in a database, making an inquiry about a topic, creating at least one personal card based on the inquiry with information regarding the topic and linking personal card to at least one public card and exploring the at least one public card for content matching the topic of the at least one personal card, then using matching content from the at least one public card as assistance for the first topic, by creating an action plan with steps or items linked to the matching content on the personal card and executing at least one of the steps or items of the action plan and verifying execution of the at least one the steps or items of the action plan on the personal card and completing the personal card with verification information on the personal card.

### CLAIM OF PRIORITY

This non-provisional application claims priority to U.S. provisional application 62/448,769 filed on Jan. 20, 2017, the contents of which is fully incorporated by reference in its entirety.

### FIELD OF THE EMBODIMENTS

The field of embodiments of the present invention related to a combination yarn with improved resilience, longer lifecycle, and improved flexibility attributes.

### BACKGROUND OF THE EMBODIMENTS

Five basic principles help drive humanity forward:

1) Spirit of Identity, and trying to know more about who you are;

2) Vision: giving a path to the future;

3) Achievement: gives meaning to our live and rewards our efforts;

4) Giving back: helps make a difference in others' lives and build their futures; and

5) Curiosity makes life interesting and moving forward.

These principles are connected to each other. In order to accomplish higher purposes, our goals and projects should be in line with the visions throughout the execution of said projects. The present application helps a user link said principles in order to accomplish a final goal.

Typically, the execution portion is the most difficult part where people face the real challenges, including:

1) Lack of knowledge and clarity—this causes people to spend most of their time on trying to figure out what are the tasks or steps required to complete project and goal or how to do.

2) Lack of guidance and support—this leads most people to slowdown or stop short altogether of completing projects and achieving goals i.e. if people get stuck with crowdfunding or crowdsourcing, or similar issues, and more.

3) Technology challenges can lead to too many sites, apps, and noise information and make it hard for common people, non-tech savvy or limited education personnel to utilize technology towards projects or goals which causes even less productivity. Focusing on this challenge, people use many sites or apps: 1) For social networking, they use Facebook, Twitter, Google+, LinkedIn, and more 2) For search, they use Google or Bing. 3) For content knowledge, they use Wikipedia, wikiHow, YouTube, Scribd, SlideShare, and more. 4) For Q&A, they use Ask.com, Quora, Yahoo Answers. Jelly, and more. 5) For buy and sell, they use Amazon, eBay, Craigslist. and more. 6) For fund raising, they use Kickstarter, Indiegogo, GoFundMe, and more. 7) For crowdsourcing, they use Elance, oDesk, DesignCrowd, 99Designs, and more.

People are spending more time on every task, goal, and project and make the “achievement process” is very slow paced despite best efforts from an individual. It is hard to solve above said three big challenges with one solution as it consists of many interconnected sub-problems. Hence, it requires a simplified, comprehensive sohlution, technology convergence, and collaborative effort to accelerate through the achievement portion of a process. A review of related technology present the following publications.
U.S. Pub. 2012/0035975 pertains to creation of detailed work plan related to works of assembling a large scale structure, such as plant construction, is aided by enabling parallel works on plural components in a work area and avoiding spatial interference between works. A method for creating detailed work plans includes step of generating component groups by dividing plural components for large scale structure into work assignment units, step of assigning the respective component groups to one or more work teams assigned in an outline process plan, step of creating each detailed work plan by determining the execution sequences of detailed works on component-by-component basis in a corresponding work team, using work sequence restriction and a work priority rule, and step of avoiding work interference that revises the execution sequence of the detailed works such as to avoid overlapping between work spaces among the determined detailed works if spatial overlapping is present among detailed works.
U.S. Pub. 2003/0036947 pertains to systems and techniques for managing the submission of ideas in an organization. According to one technique, ideas are collected and entered into an electronic archive accessible through a network. This is followed by displaying the ideas to members of the organization so that the members of the organization can provide additional thoughts related to the submission. The ideas are then provided to a management screening committee for screening. The screened ideas are then submitted to an idea sponsor. This is followed by an opportunity screening phase, in which the submitted, screen ideas are further developed and evaluated. A further aspect of the described systems and techniques provides an idea submission tool for submission of ideas using a web-based interface.
U.S. Pub. 2003/0093310 pertains to a method for managing a business utilizing a business management process (BMP). According to one embodiment of the invention, a framework is developed for the BMP, a business and technology strategic plan is identified, strategic trends for the business are identified, one or more plans for producing goods and/or services are developed, strategic goals are defined, corporate resources are allocated to execute the business and technology strategic plan, and the business and technology strategic plan is executed.

However, none of the art described above addresses all of the issues that the embodiments of the present invention do. A need still exists for a step by step process that enables a user to achieve their goal and tool for ensuring that the goal is being met.

### SUMMARY OF THE EMBODIMENTS

A method and system for a card based Advanced Social Productivity Platform (ASPP)—called OneworldX, provides a fast and efficient way for people to achieve what they love and want, and helps unleash their potential. The OneworldX platform is built on three pillars:

1) The card, also henceforth called the The AchieveX-card, can be powered by Krish-AI, simplifies the creating and managing processes for projects, goals, and events associated with education, career, and self-improvement.

2) The card is built upon The Global Accelerated Achievement Model (GAAM) helps quickly respond with possible solutions and support that people need to solve problems through collaborative engagement with other people, business and organization across the world (i.e OneworkiX ecosystem).

3) The simplified 5Es holistic framework provides two approaches for accomplishing higher purpose of life: Inside-out is primary way starts from know true-self and envision to achieve what you love and want. Outside-in is secondary way starts from know what is happening around you and make necessary changes in you to achieve what you love and want.

The OneworldX platform helps accelerate the socio-economic development and transformation as a whole across the world by using the 5Es holistic framework and the Global Accelerated Achievement Model (GAAM).

It is to be understood that the present invention is not limited to the particular methodology, system, techniques, uses, and applications, described herein, as these may vary. It is also to be understood that the terminology used herein is used for the purpose of describing particular embodiments only, and is not intended to limit the scope of the present invention.

In addition to the foregoing, other objects, features, aspects and advantages of the present invention will be better comprehended through a careful reading of a detailed description provided herein below with appropriate reference to the accompanying drawings.

### BRIEF DESCRIPTION OF THE DRAWINGS

FIG. 1 shows a flow chart depicting the in accordance with an embodiment of the present invention.

FIG. 2 shows a pyramid diagram in accordance with an embodiment of the present invention.

FIG. 3 shows an exemplary flow chart depicting the sub-modules of the framework in accordance with an embodiment of the present invention.

FIG. 4 shows an exemplary flow chart depicting the process for new user registration in accordance with an embodiment of the present invention.

FIGS. 5A-5B show an exemplary flow chart depicting the process for an individual creating and managing a process in accordance with an embodiment of the present invention.

FIGS. 6A-6B show an exemplary flow chart depicting the process for an entity in accordance with an embodiment of the present invention.

FIG. 7 shows an exemplary flow chart depicting the process in accordance with an embodiment of the present invention.

FIG. 8 shows exemplary flow chart depicting the process for Global Accelerated Achievement Model in accordance with an embodiment of the present invention.

FIG. 9 shows an exemplary flow chart depicting an Advanced Social Productivity Platform in accordance with an embodiment of the present invention.

FIG. 10 shows a flow chart depicting the process for breaking down a complex process and improving process efficiency for an Advanced Social Productivity Platform in accordance with an embodiment of the present invention.

FIG. 11 shows a main card linked with sub cards for an Advanced Social Productivity Platform in accordance with an embodiment of the present invention.

FIG. 12 shows exemplary flow chart depicting the process for an individual to “Know more yourself” using a module based Advanced Social Productivity Platform in accordance with an embodiment of the present invention.

FIG. 13 shows an exemplary flow chart depicting a portion of the process in accordance with an embodiment of the present invention.

FIG. 14 shows an exemplary flow chart depicting the process for both individual and entity in accordance with an embodiment of the present invention.

FIG. 15 shows exemplary flow chart depicting the process for individuals and entities for a complete transformation in accordance with an embodiment of the present invention.

FIGS. 16A-16B show an illustration of socio-economic development and transformation from individual entity to world entity in accordance with an embodiment of the present invention.

FIG. 17 shows an architectural block diagram for building advanced user interface in accordance with an embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

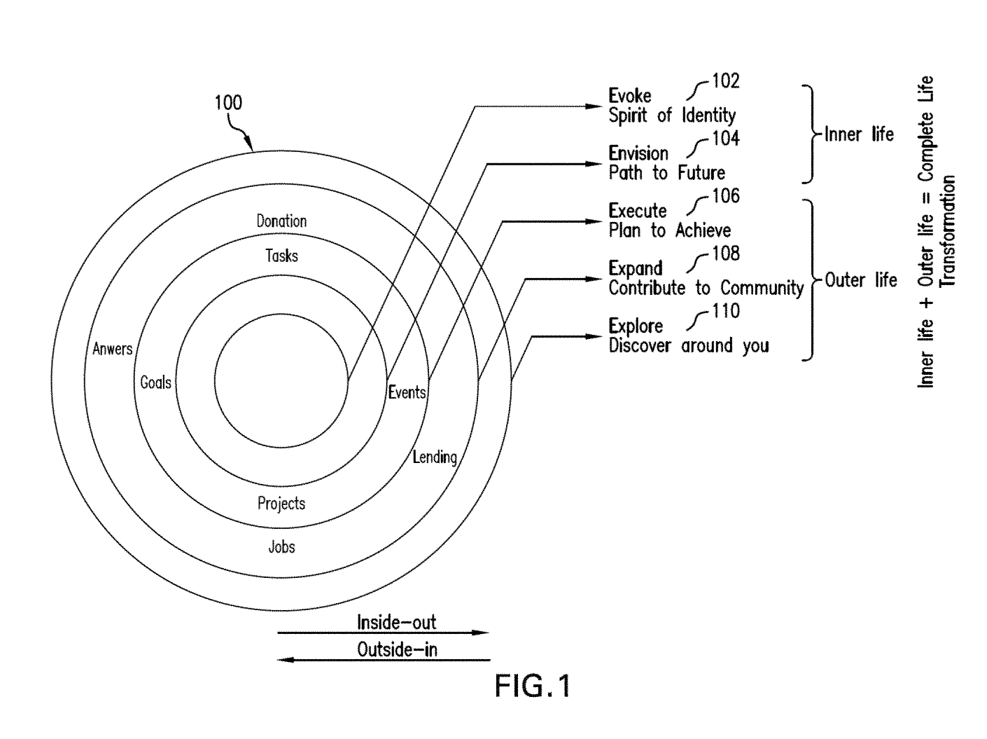

FIG. 1 shows an exemplary flow 100 chart depicting the process for simplified 5Es holistic framework for a card hereinafter referred to as the AchieveX-card based Advanced Social Productivity Platform (ASPP)—OneworldX, in accordance with an embodiment of the present invention. The 5Es framework is aligned using five items that drives our life: 1) Spirit of Identity 2) Vision 3) Achievement 4) Giveback 5) Curiosity. The five components of the framework are intertwined and interdependent:

1) Evoke—Spirit of Identity 102, by knowing more about who you are or true-sell rectify what is wrong, and strengthen what makes you special to be successful in life. Who you are is the sum of What you believe, How you express yourself How you keep yourself What you can do, and What you are best at, for more detail refer the FIG. 12, FIG. 13.

2) Envision—Path to Future 104, envision you're near future by knowing what would make your life more exciting and happy? Or where do you see yourself in 5 or 10 years from now? For more detail refer the FIG. 14.

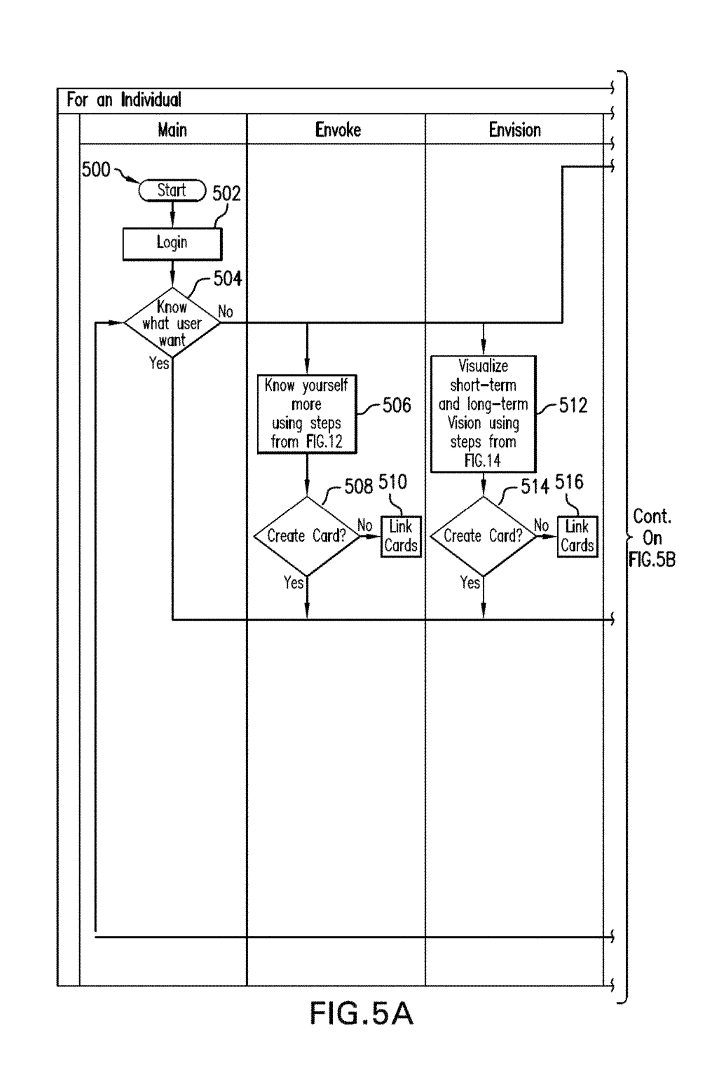

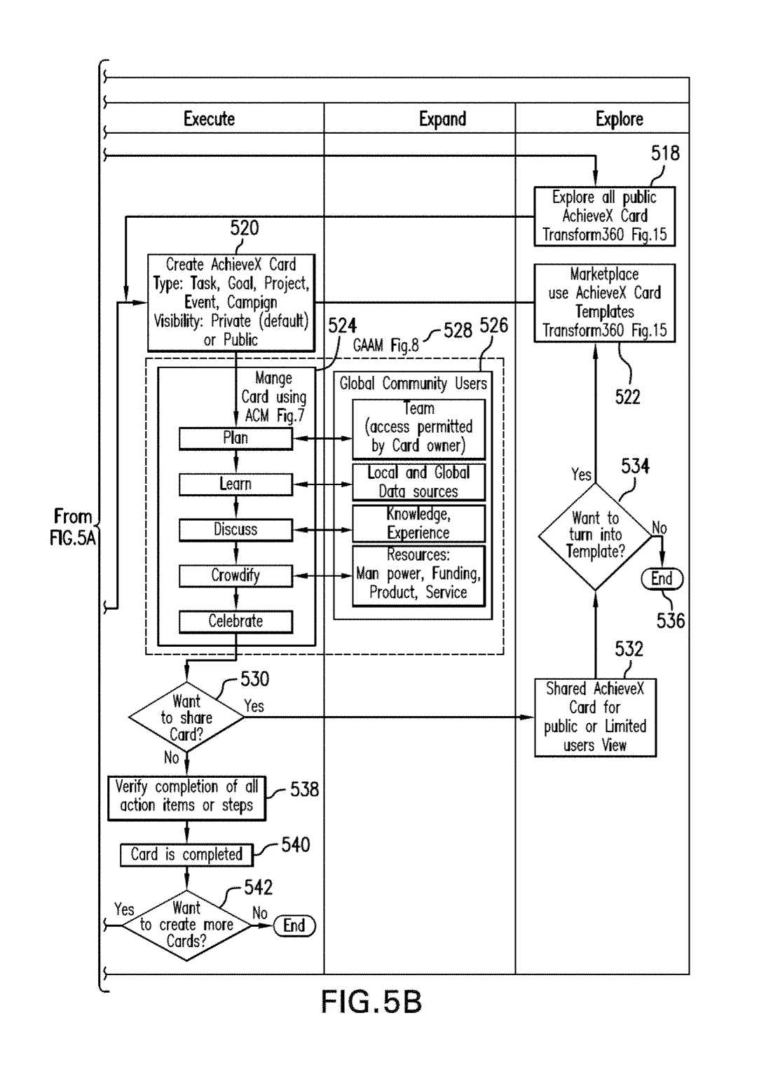

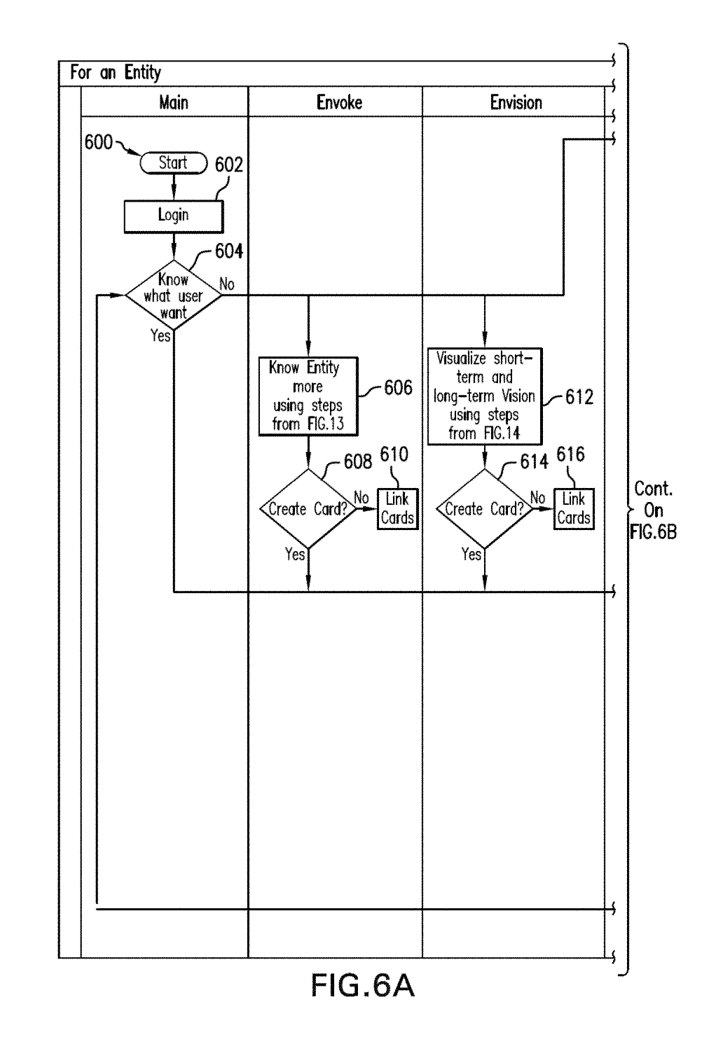

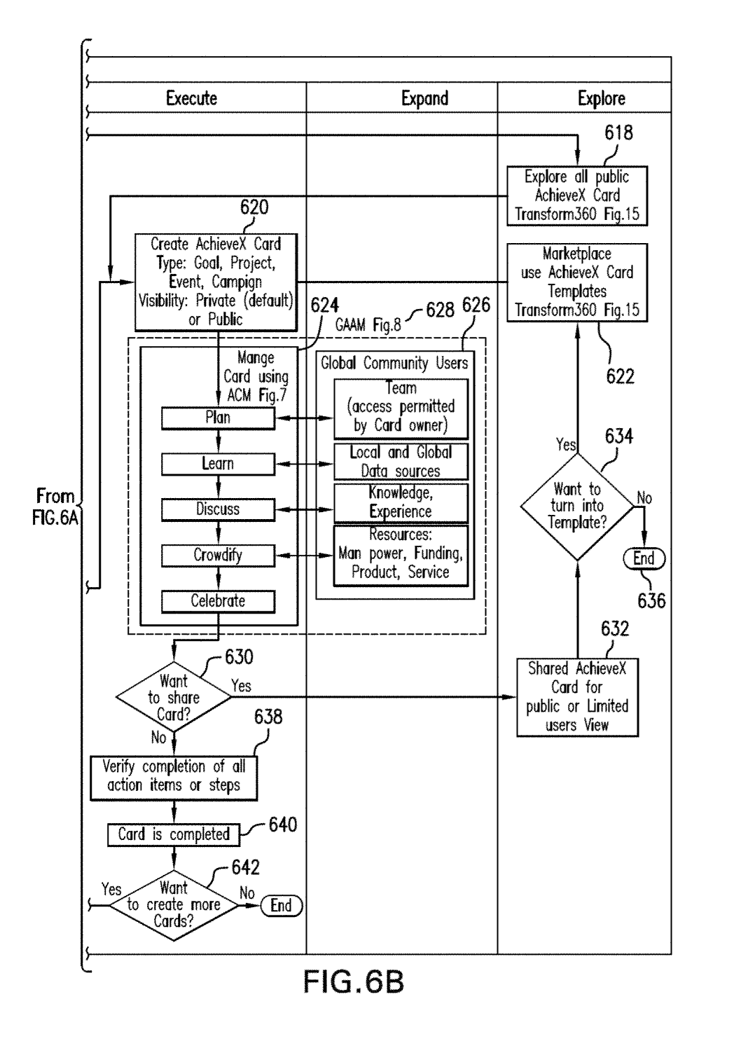

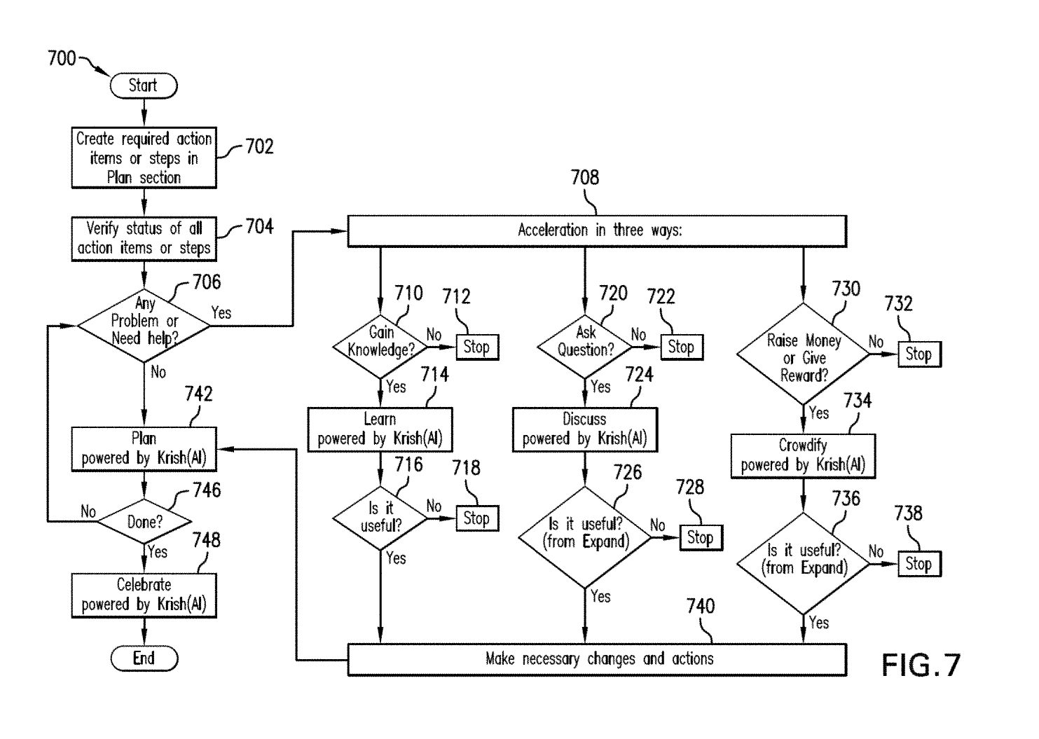

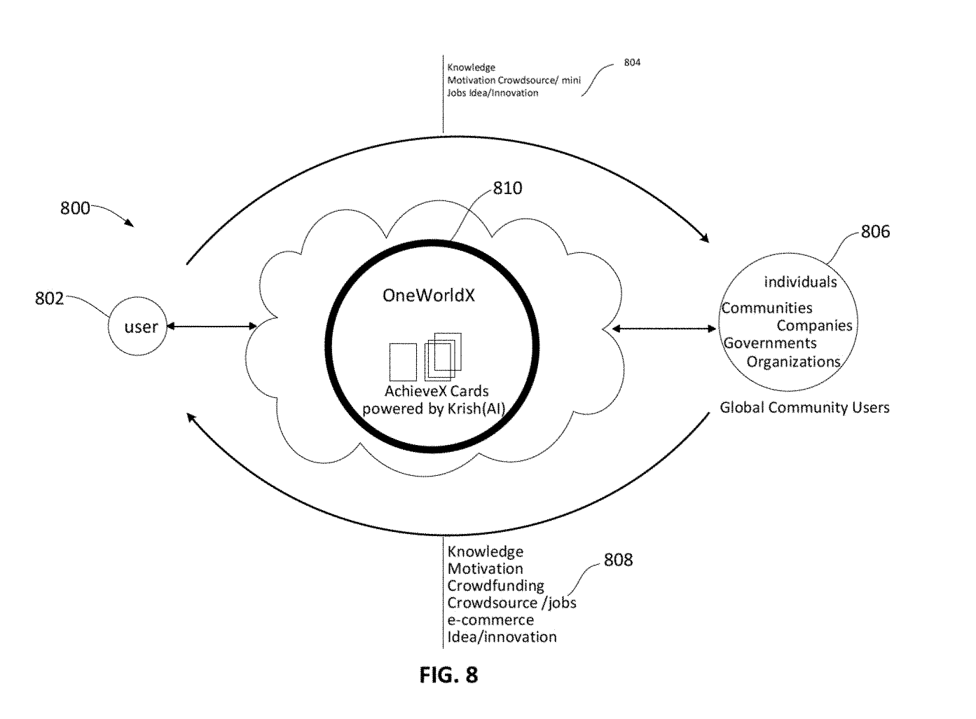

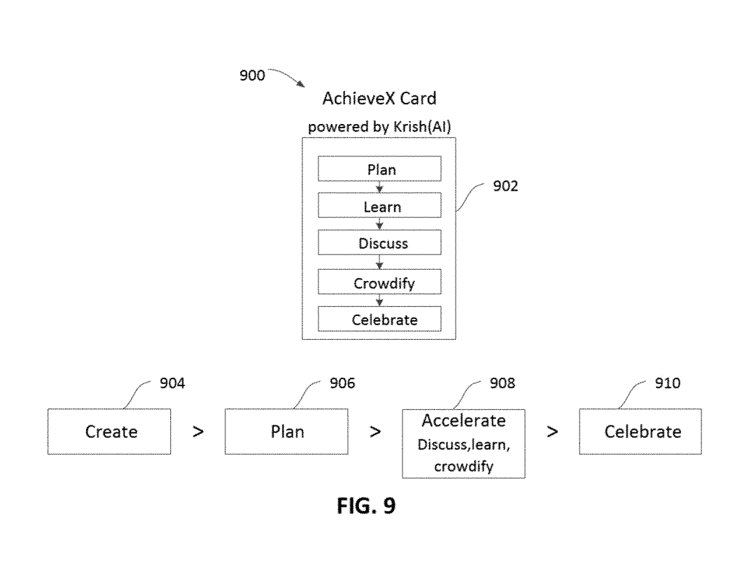

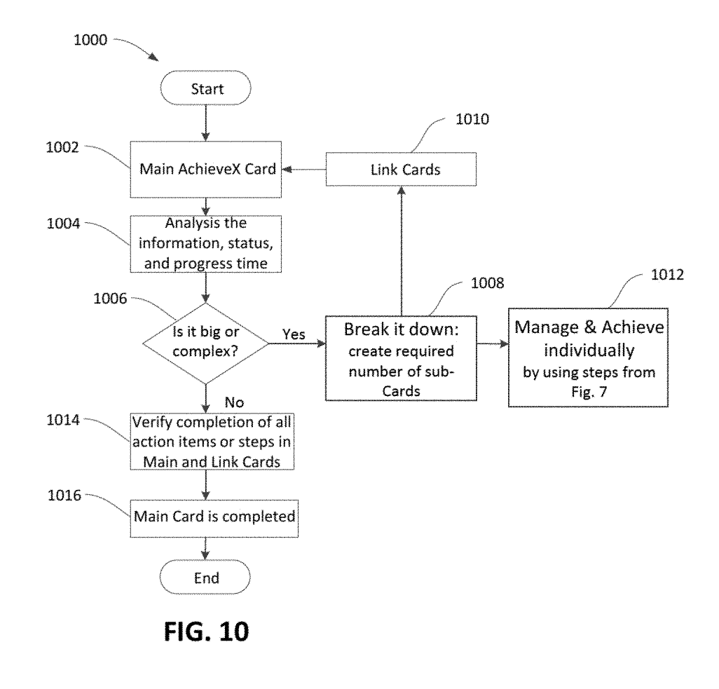

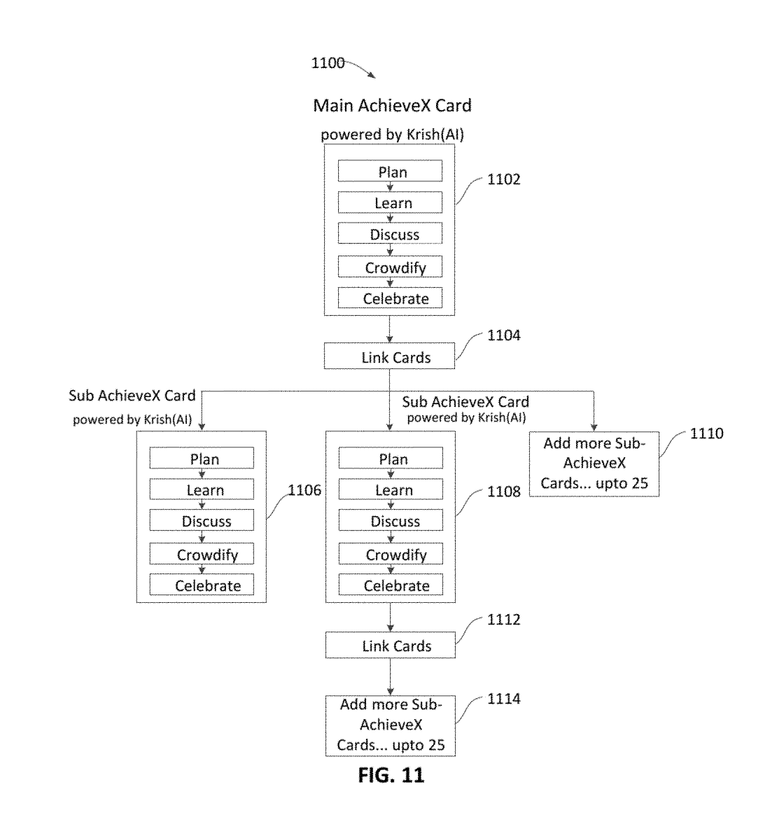

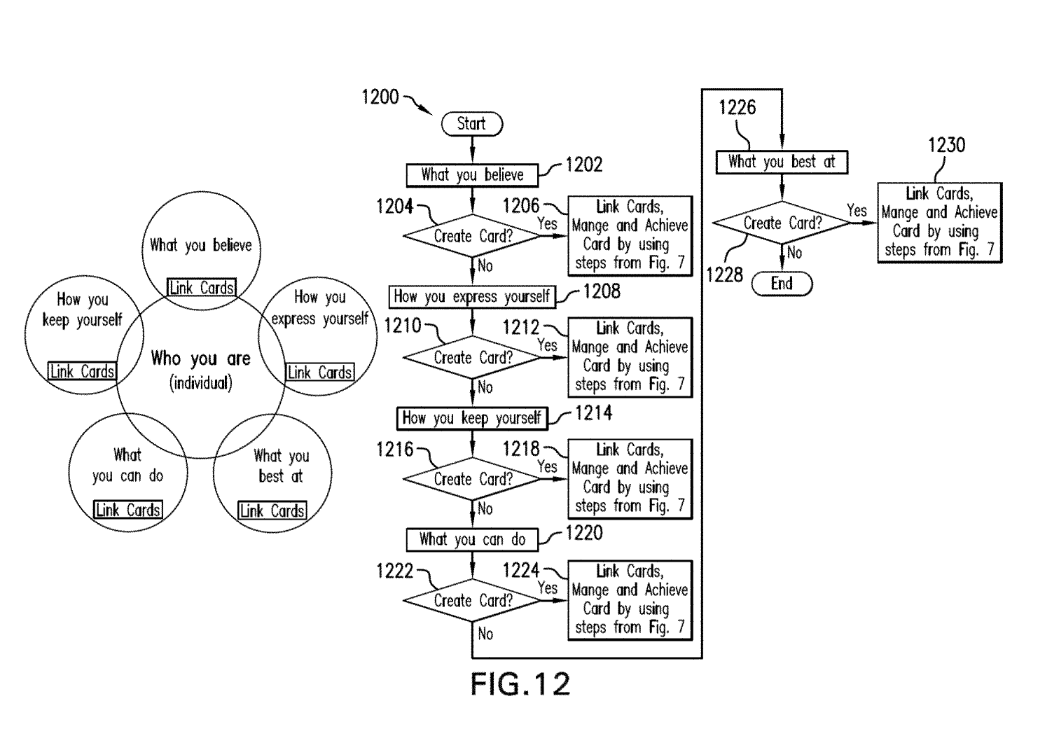

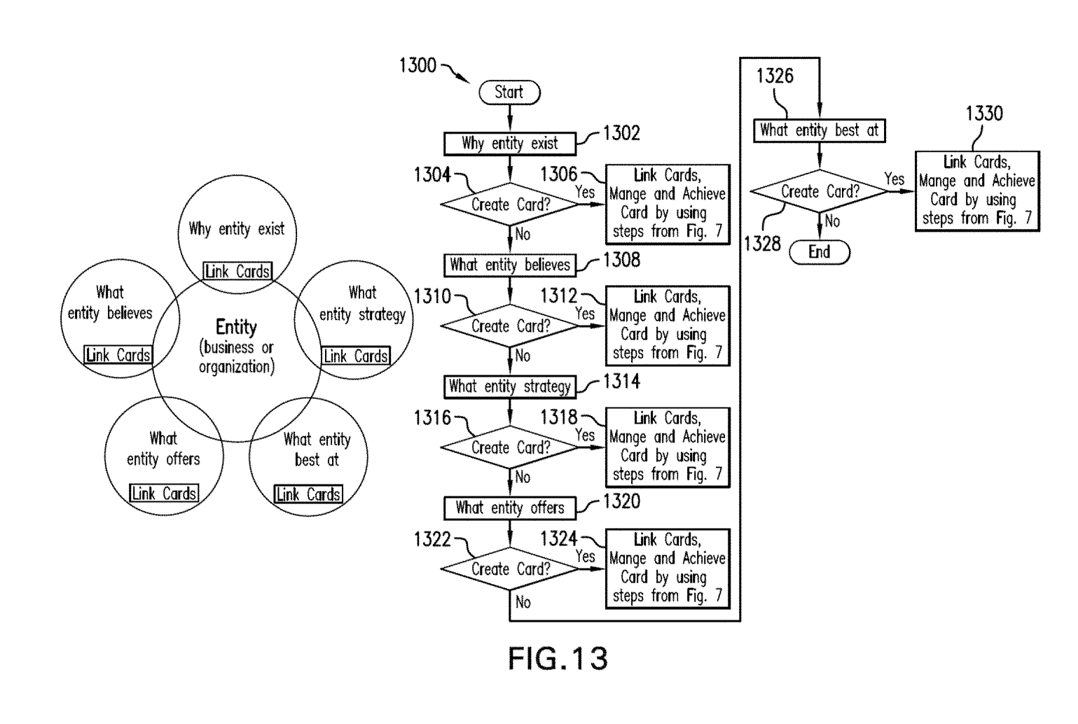

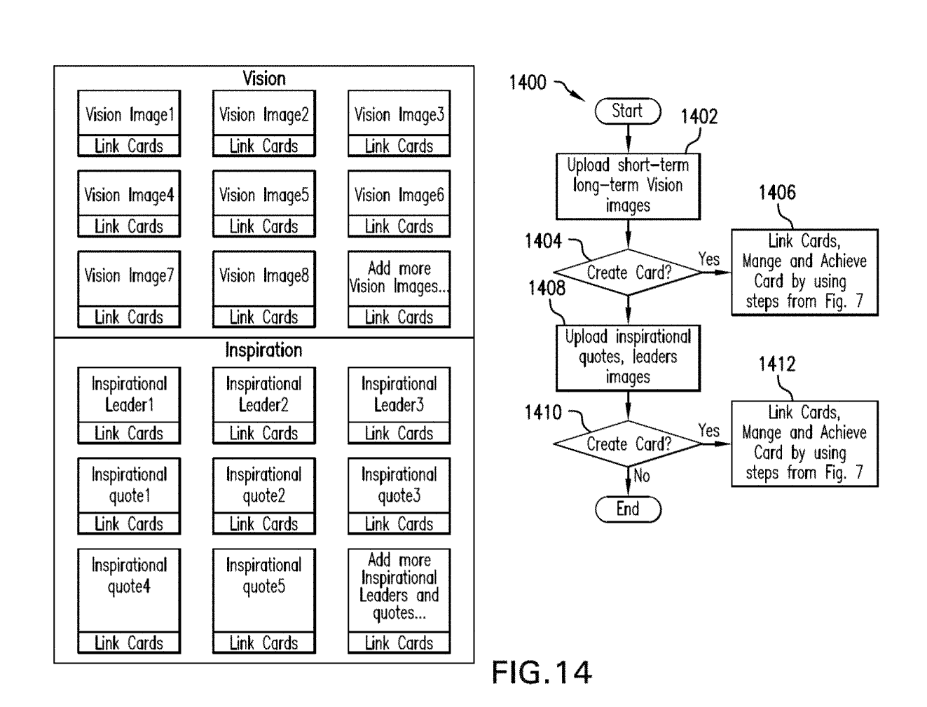

3) Execute—Plan to Achieve 106, execute the plan for projects, goals, events that fulfill your vision and daily life by creating AchieveX-card that accelerate your achievement in less time and effort), for more detail refer the FIG. 5, FIG. 6, FIG. 7, FIG. 9, FIG. 10, FIG. 11.

4) Expand—Contribute to Community 108, expanding your contribution to communities and friends that makes difference in others life by answering questions, taking contract jobs, giving donations, and lending money from Discuss 724 and Crowdify 734. This module follows the Global Accelerated Achievement Model (GAAM), for more detail refer the FIG. 7, FIG. 8.

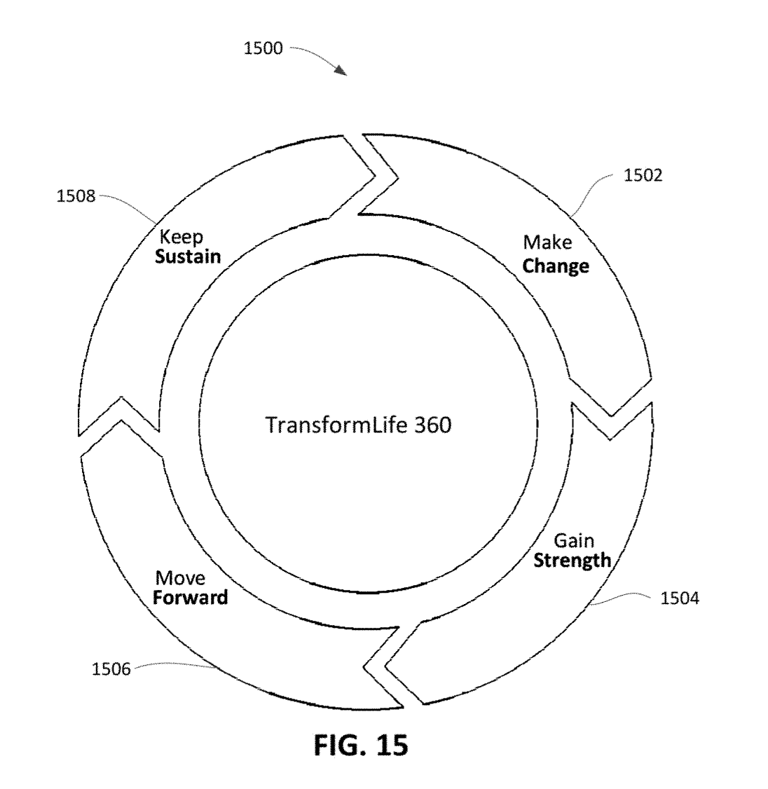

4) Explore—Discover around you 110, explore to discover what is happing around you and things you curious about, join team if you want to part of it, continue to improve yourself. This follows the TransformLife 360, for more detail refer the FIG. 15.

The simplified 5Es holistic framework provides two approaches for accomplishing higher purpose of life: 1) Inside-out is primary way starts from know true-self and visualize to achieve what you love and want. 2) Outside-in is secondary way starts from know what is happening around you and make necessary changes in you to achieve what you love and want. The Inside-out together with Outside-in is a Complete Life Transformation.

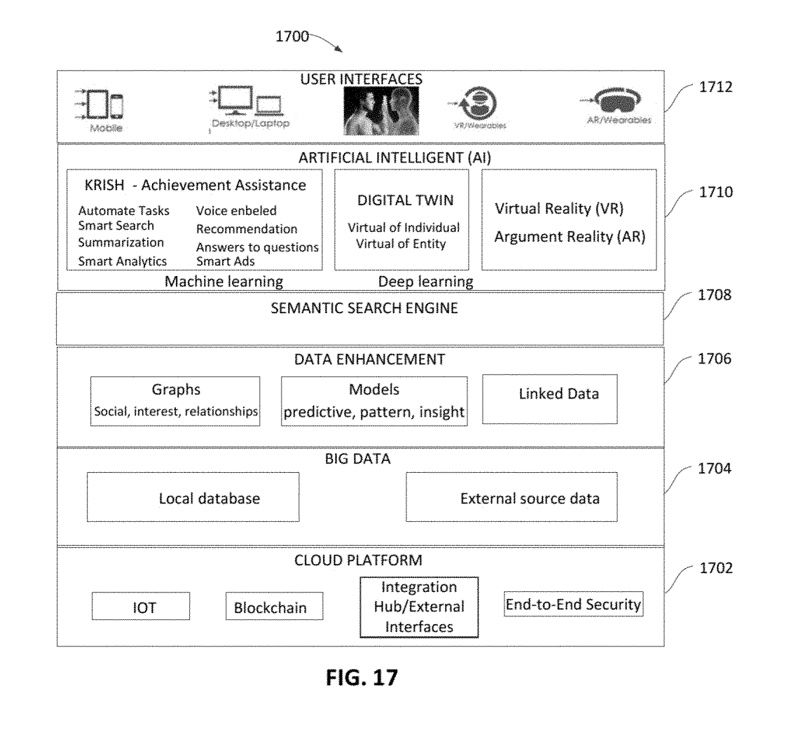

Referring again to FIG. 1, the three modules such as Execute, Expand, Explore are fully powered by Krish (AGI). The Evoke and Envision modules are limited powered by Krish (AGI) to capture the users own thinking and vision as well as avoiding any way of manipulating users, for more detail refer the FIG. 17.

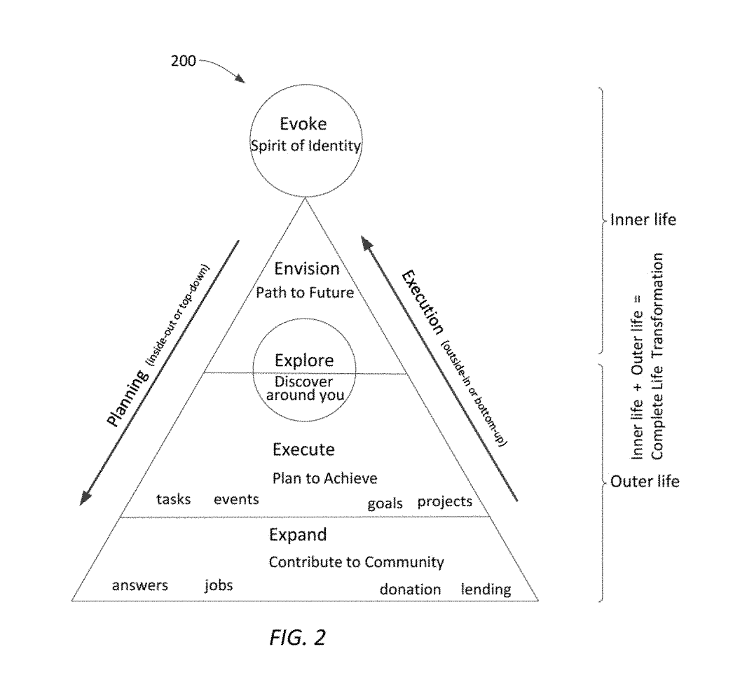

FIG. 2 is shows the simplified 5Es holistic framework in Pyramid diagram 200 for an AchieveX-card based Advanced Social Productivity Platform (ASPP)—OneworldX, in accordance with an embodiment of the present invention. The diagram represents the simplified 5Es holistic framework in Pyramid diagram way for high-level understanding.

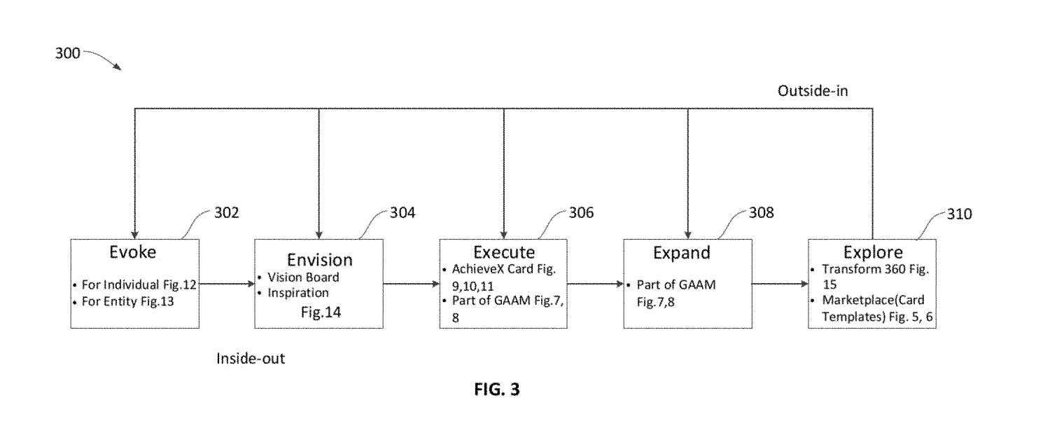

FIG. 3 is shows exemplary flow chart 300 depicting the sub-modules in simplified 5Es holistic framework for an AchieveX-card based Advanced Social Productivity Platform (ASPP)—OneworldX, in accordance with an embodiment of the present invention. The sub-modules in simplified 5Es holistic framework makes the OneworldX platform unique and extremely powerful for socio-economic development and transformation across the world. 1) Evoke module 302, has two key sub-modules: 1.1) know-more-yourself (who you are) submodules for an individual, for more detail refer the FIG. 12. 1.2) know-more-entity submodules for an Entity, for more detail refer the FIG. 13. 2) Envision module 304, has Vision board submodules for both individual and entity, for more detail refer the FIG. 14. 3) Execute module 306, has two key sub-modules: 3.1) AchieveX Card and its submodules for both individual and entity, for more detail refer the FIG. 9, FIG. 10, FIG. 11. 3.2) it has a part of Global Accelerated Achievement Model (GAAM) submodules for both individual and entity, for more detail refer the FIG. 7, FIG. 8. 4) Expand module 308, has a part of Global Accelerated Achievement Model (GAAM) submodules for both individual and entity, for more detail refer the FIG. 7, FIG. 8. 5) Explore module 310, has two key sub-modules:
5.1) TransformLife 360 system and its submodules for both individual and entity, for more detail refer the FIG. 15.
5.2) Marketplace (AchieveX card templates) submodules for both individual and entity, for more detail refer the FIG. 5. FIG. 6.

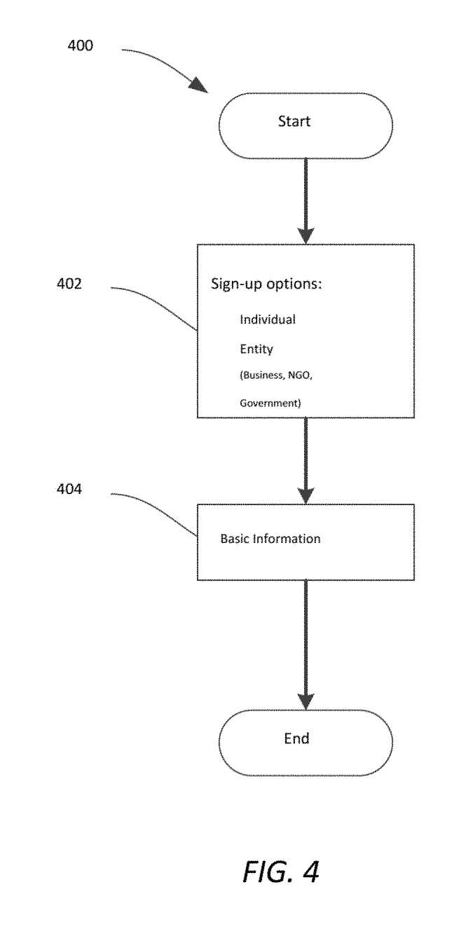

FIG. 4 is an illustration of exemplary flow chart 400 depicting the process for new user registration for an AchieveX-card based Advanced Social Productivity Platform (ASPP)—OneworldX, in accordance with an embodiment of the present invention. OneworldX platform provides two types of sign-up options 402 during user registration process such as individual and entity (business, NGO (non-government organization), and governnnent organization). Upon the type selection, user will enter basic information 404 such as email address and password for completing the registration.

FIGS. 5A-5B show an exemplary flow chart 500 depicting the process for individual creating and managing the AchieveX-card for an AchieveX-card based Advanced Social Productivity Platform (ASPP)—OneworldX, in accordance with an embodiment of the present invention. Upon the user login 502 into the OneworldX platform, if user does not know what they want and need, then there are three ways 504 of going forward: 1) Evoke module 506 that evoke the great spirit of identity by knowing more about who you are, rectify what is wrong, and strengthen what makes you special to be successful in life, for more detail refer the FIG. 12. Based on users own evaluation or system provided recommendations people can create new AchieveX-card 508 or Link the existing AchieveX-card 510 to achieve. 2) Envision module 512, envision individual short-term and long-term vision, for more detail refer the FIG. 14. Based on users own evaluation or system provided recommendations people can create new AchieveX-card 514 or Link the existing AchieveX-card 516 to achieve. 3) The Explore module 518 provides set of interested topics or fields that focus on what really matter for the complete life transformation using the TranformLife 360 model. This guides and motivates the people to create the required AchieveX-cards, for more detail refer the FIG. 15.

Referring again to FIGS. 5A-5B, once identified, user can create an AchieveX-card (Type: Task, Goal, Project, Event) 520 by entering title, description, and other information if needed. Alternatively, user can quickly create an AchieveX-card by picking or exploring any existing AchieveX-card templates 522 in Marketplace that match their need, and then simply click copy to create a card. User can continue to manage and achieve the AchieveX-card 524 by using ACM steps from FIG. 7. By default, the AchieveX-card saved as private (not visible to public). However, user has a full control to change 530 any three options such as public, in-network, and individuals for sharing their cards with others 532. If user wants 534 to turn their any AchieveX-card into templates by simply clicking button then it will be available in Marketplace 522 for anyone to use it free by default. However, user has option to set the certain price for each of their template and other users have to buy before using it, this way user can earn money. User will verify completion of all action items or steps 538, if everything okay, user can set the AchieveX-card status into completion 540. If the user want to create 542 more AchieveX-cards, then follow the same process by starting from step 504.

Referring again to FIGS. 5A-5B, OneworldX global community users 526 share the knowledge, experience, answers, data, funding, and services to accelerate the AchieveX-card. In addition, card owner can include the other interested users as team members in the AchieveX-card for team or group achievement. The Global Accelerated Achievement Model (GAAM) 528 is a combination of ACM 524 and Global community users' contribution 526, for more detail refer the FIG. 7, FIG. 8. GAAM is the sum of ACM 524 and Global community users contribution 526.

FIGS. 6A-6B is an illustration of exemplary flow chart 600 depicting the process for entity (like business, organization, and government) creating and managing the AchieveX-card for an AchieveX-card based Advanced Social Productivity Platform (ASPP)-OneworldX, in accordance with an embodiment of the present invention. Upon the user login 602 into the OneworldX platform, if entity user (like business, organization, and government) don't know what they want and need, then there are three ways 604: 1) Evoke module 606 that evoke the great spirit of identity by knowing more about entity, rectify what is wrong, and strengthen what makes entity special to be successful, for more detail refer the FIG. 13. Based on entity user own evaluation or system provided recommendations employees can create new AchieveX-card 608 or Link the existing AchieveX-card 610 to achieve. 2) Envision module 612, envision what is the entity short-term and long-term vision, for more detail refer the FIG. 14. Based on entity user own evaluation or system provided recommendations employees can create new AchieveX-card 614 or Link the existing AchieveX-card 616 to achieve. 3) The Explore module 618 provides set of interested topics or fields that focus on what really matter for entity complete life transformation using the TranformLife 360 model. This guides and motivates the employees to create the required AchieveX-cards, for more detail refer the FIG. 15.

Referring again to FIGS. 6A-6B, once identified, user can create an AchieveX-card (Type: Goal, project, campaigns, and event) 620 by entering title, description, and other information if needed. Alternatively, user can quickly create an AchieveX-card by picking or exploring any existing AchieveX-card templates 622 in Marketplace that match their need, and then simply click copy to create a card. User can continue to manage and achieve the AchieveX-card 624 by using ACM steps from FIG. 7. By default, the AchieveX-card saved as private (not visible to public). However, user has a full control to change 630 any three options such as public, in-network, and individuals for sharing their cards with others 632. If user want 634 to turn their any AchieveX-card into templates by simply clicking button then it will be available in Marketplace 622 for anyone to use it free by default. However, user has option to set the certain price for each of their template and other users have to buy before using it, this way user can earn money. User will verify completion of all action items or steps 638, if everything okay, user can set the AchieveX-card status into completion 640. If the user want to create 642 more AchieveX-cards, then follow the same process by starting from step 604.

Referring again to FIGS. 6A-6B, OneworldX global community users 626 share the knowledge, experience, answers, data, funding, and services to accelerate the AchieveX-card. Also, card owner can include the interested other users as a team in the AchieveX-card for team or group achievement. The Global Accelerated Achievement Model (GAAM) 628 is a combination of ACM 624 and Global community users contribution 626, for more detail refer the FIG. 7, FIG. 8. GAAM is the sum of ACM 624 and Global community users contribution 626.

FIG. 7 is an illustration of exemplary flow chart 700 depicting the process for Achieve Card Method (ACM) which accelerating the problem solving and other needs for an AchieveX-card based Advanced Social Productivity Platform (ASPP)—OneworldX, in accordance with an embodiment of the present invention. User creates all required action items or steps in Plan section 702 one by one if they know or user can quickly add from Krish (AGI) recommended steps or activities. Also. Krish (AGI) automates repetitive tasks in the plan section to save the user time and effort, for example sending email acknowledgement. User continues to review the status of all action items or steps 704 on daily basis, if they find any problems or need help 706, they then follow the acceleration approach 708 to solve the problems and fulfill the needs through collaborative engagement with other people, business, organization, and government in the system in three possible ways: 1) if user need to gain knowledge 710 relevant to title or task or steps or action items, and then go through the Learn 714 section where system provides relevant contents from different sources: wiki, how-to, training courses, product, and service. If user finds useful 716, then incorporate 740 that as an action in “Plan” section 742. 2) If the user wants to ask questions for clarity and guidance 720, then go through the Discuss 724 section to engage with likeminded people, mentors, and accelerators for their answers. If user finds useful 726, then incorporate 740 that as an action in “Plan” section 742. 3) If the user wants to raise money or crowdsource/outsource the task or activity 730, then go through the Crowdify 734 section to engage with friends, likeminded people, investors, freelancer, independent contractors, and business. If the user finds useful 736, then incorporate 740 that as an action in “Plan” section 742.

Referring again to FIG. 7, user continue to make progressive action in the “Plan” section 742, then verify the status of completion 746, If they found any problem and need help 706 then follow the steps in the acceleration approach 708 as mentioned above. If everything okay, user can set the task or activity status into completion. In Celebrate 748 section, user can share their joy while doing as well as upon achievement with others by uploading the photos, sending gifts to contributors, scheduling a party event and fun trips.

Referring again to FIG. 7, the Learn 712 is consist of two components which part of Krish (AGI): 1) Right Content Module, provides tailor made contents that more relevant to AchieveX-card's action items or steps by using recommendation system algorithms from internal and external sources: wiki, how-to, training courses, and more. 2) Product and Service Module, provides tailor made product and service that more relevant to AchieveX-card's action items or steps by using recommendation system algorithms from internal and external sources: Amazon, eBay, independent service providers, and more.

Referring again to FIG. 7, the Discuss 724 has AskAny Module, provides simplified forum that helps user to ask questions for clarity and guidance through collaborative engagement with accelerators, likeminded people, and mentors for their answers. Krish (AGI), provides a list of Top-10 persons who can potentially respond timely manner, it promotes all questions to potential other users in the OneworldX community by using recommendation system algorithms. On top of it, Krish (AGI) answers to user questions directly by using deep learning algorithm models build on top of Big data.

Referring again to FIG. 7, the Crowdify 734 is consist of two components: 1) Funding Module, process the user request for raising fund to support identified action items or steps to accelerate the achievement through loan with flat interest rate and donation options. Krish (AGI), promotes all funding request to potential lenders and donors by using recommendation system algorithms. It will record all financial transaction for tracking and managing purpose for users, lenders, investors, and donors. 2) Talent Acquisition Module, process the user request for crowdsourcing/outsourcing identified action items or steps effort to accelerate the achievement through 3rd party service providers. Krish (AGI), promotes all contract hiring request to potential freelancer, independent contractors, and business by using recommendation system algorithms. It will record all financial transaction for tracking and managing purpose for users and service providers.

FIG. 8 is an illustration of exemplary flow chart 800 depicting the process for Global Accelerated Achievement Model (GAAM) for an AchieveX-card based Advanced Social Productivity Platform (ASPP)—OneworldX, in accordance with an embodiment of the present invention. In short, the model represents the interaction and exchange of information between users (individual and entity) and global community users for mutual benefits in OneworldX ecosystem 810. User (individual or entity) 802 creates set of AchieveX-cards in OneworldX platform based on what they love to do or want. While achieving each AchieveX-card or helping someone user shares and exchange information 804 in the form of Knowledge, Motivation, Crowdsource/mini Jobs, Idea/Innovation. In response, other users (individual or entity) 806 in the ecosystem 810 offers help or assist the requested user by sharing and exchanging information 808 in the form of Knowledge, Motivation, Crowdfunding, Crowdsource/jobs, e-commerce, Idea/innovation. The Global Accelerated Achievement Model (GAAM) 628 is a combination of ACM 624 and Global community user contribution 626, for more detail refer the FIG. 5, FIG. 6, FIG. 7.

FIG. 9 is an illustration of exemplary flow 900 chart depicting the four simple steps in single AchieveX-card achievement process for an AchieveX-card based Advanced Social Productivity Platform (ASPP)—OneworldX, in accordance with an embodiment of the present invention. This represents the simpler form of covering FIGS. 5A-SB and FIG. 7 process. Other words, key steps in single AchieveX-card 902 achievement process. Step1, user create 904 an AchieveX-card. Step2, enter the all required action items or steps in Plan 906 section and make progress by doing incremental work every day. Step3, if any problem or need help, accelerate 908 and resolve it through three ways: Learn, Discuss, and Crowdify. Step4, Celebrate 910, share your joy while doing and upon achievement.

FIG. 10 is an illustration of exemplary flow chart 1000 depicting the process for breaking down the big or complex AchieveX-card into sub-AchieveX-card or link-AchieveX-card for improving the process efficiency for an AchieveX-card based Advanced Social Productivity Platform (ASPP)—OneworldX, in accordance with an embodiment of the present invention. On daily basis, user reviews 1002 main AchieveX-card progress time and analysis 1004 the insight analytics provided by Krish (AGI). If the user identifies the main AchieveX-card as a big or complex 1006, then break it down 1008 into required number of independent sub-AchieveX-card and import 1010 them into main AchieveX-card in that way it links with main AchieveX-card. Also, user can import 1010 the existing independent AchieveX-card that is relevant to this main AchieveX-card. Now, user can manage and achieve 1012 all sub-AchieveX-card individually by using steps in FIG. 7. User verifies completion of all action items or steps in Main as well as Link Cards 1014, if everything okay, user can set the main AchieveX-card status into completion 1016.

Referring again to FIG. 10, the entity user (like business, organization, and government) follows same process illustrated in FIG. 10 for breaking down the big or complex AchieveX-card into sub-AchieveX-card or link-AchieveX-card for improving the process efficiency.

FIG. 11 is an illustration of how 1100 main AchieveX card linked with sub-AchieveX cards for an AchieveX-card based Advanced Social Productivity Platform (ASPP)—OneworldX, in accordance with an embodiment of the present invention. The main AchieveX card is linked with sub-AchieveX cards in the process of breaking down the big or complex AchieveX-card into sub-AchieveX-card, for more detail refer the FIG. 10. User can click the Link cards 1104 button to attach one or more sub-AchieveX-card 1106, 1108 up to 25 cards 1110. In addition, in each sub-AchieveX-card 1108, user can link one or more sub-AchieveX-cards up to 25 cards 1114 by clicking the Link cards button 1112.

FIG. 12 is an illustration of exemplary flow chart 1200 depicting the process for an individual to know more yourself (Who you are) using Evoke (Spirit of Identity) module for an AchieveX-card based Advanced Social Productivity Platform (ASPP)—OneworldX, in accordance with an embodiment of the present invention. The Evoke module that evoke the great spirit of identity by knowing more about who you are, rectify what is wrong, and strengthen what makes you special to be successful in life. There are five components in this module 1.1) what you believe 1202, your characters lays the foundation or primary traits for long-term success in your life. It attributed more to underlying principles and values in which some absolute principles that exist in all human being. System provides recommendation on globally recognized principles and values. Based on user own evaluation or system provided recommendations people 1204 can create new or Link the existing AchieveX-card to achieve 1206. 1.2) how you express yourself 1208, your Personality is secondary traits for short and long term success in your life. It attribute of your behavior and attitudes towards others. System helps to know your personality type by using Myers-Briggs type indicator quiz and provides recommendation on personality development including positive attitude. Based on users' own evaluation or system provided recommendations people 1210 can create new or Link the existing AchieveX-card to achieve 1212. 1.3) how you keep yourself 1214, our character is a collection of our habits, and habits have a powerful role in our lives. A habit is an acquired behavior or thought pattern that you have repeated so many times that it has become almost unconscious. System provides recommendation on healthy living habits (for Mind, Body & Spirit), habits for most effective people, and breaking bad habits. Based on user own evaluation or system provided recommendations people 1216 can create new or Link the existing AchieveX-card to achieve 1218. 1.4) what you can do 1220, your strength of knowledge and skills accelerates your achievement in career and personal life. Knowledge (know what) is the theoretical or practical understanding of a subject and acquired through learning or experience. Skills (know how) are the proficiencies developed through training or experience and can be developed with practice. System provides recommendation on education and gaining work experience in soft, hard, and entrepreneur skills. Based on user own evaluation or system provided recommendations people 1222 can create new or Link the existing AchieveX-card to achieve 1224. 1.5) what you best at 1226, having natural intelligence/abilities to do something best in your career or personal life and it can be improved through practice. System provides recommendation on critical and creative thinking development, multiple intelligence development (Self Smart—Intrapersonal, People Smart—Interpersonal, Number Smart—Logical, Word Smart—Linguistic, Body Smart—Kinesthetic, Music Smart—Musical, Art Smart—Visual/Spatial, Nature Smart—Naturalistic). Based on user own evaluation or system provided recommendations people 1228 can create new or Link the existing AchieveX-card to achieve 1230. Who you are is the sum of What you believe, How you express yourself: How you keep yourself What you can do, and What you are best at.

FIG. 13 is an illustration of exemplary flow chart 1300 depicting the process for an entity (like business, organization, and government) to know more about Entity using Evoke (Spirit of Identity) module for an AchieveX-card based Advanced Social Productivity Platform (ASPP)—OneworldX, in accordance with an embodiment of the present invention. The Evoke module that evoke the great spirit of identity by knowing more about entity, rectify what is wrong, and strengthen what makes entity special to be successful There are five components in this modules: 1.1) why entity exist (mission) 1302, user need to state the purpose of entity or mission statement. Based on entity user own evaluation or system provided recommendations employees 1304 can create new AchieveX-card or Link the existing AchieveX-card to achieve 1306. 1.2) what entity believes (value) 1308, state the timeless core principles and values that entity believes and. System provides recommendation on globally recognized principles and values. Based on entity user own evaluation or system provided recommendations employees 1310 can create new AchieveX-card or Link the existing AchieveX-card to achieve 1312. 1.3) what entity strategy 1314, state the entity strategies, tactics, and best practice to achieve vision. System provides recommendation on relevant strategies, tactics, and best practice. Based on entity user own evaluation or system provided recommendations employees 1316 can create new AchieveX-card or Link the existing AchieveX-card to achieve 1318. 1.4) what entity offers 1320, list the entity value propositions includes product and services. System provides recommendation on potential products and service. Based on entity user own evaluation or system provided recommendations employees 1322 can create new AchieveX-card or Link the existing AchieveX-card to achieve 1324. 1.5) what entity best at 1326, state the entity core competencies that differentiate from competitors. System provides recommendation on building competencies. Based on entity user own evaluation or system provided recommendations employees 1328 can create new AchieveX-card or Link the existing AchieveX-card to achieve 1330. The Entity of true-self is the sum of “why an entity exists (mission)”, “what the entity believes (value)”, “what the entity's strategy is”, “what the entity offers”, and “what the entity is best at.”

FIG. 14 is an illustration of exemplary flow chart 1400 depicting the process for both individual and entity (like business, organization, and government) to visualize their short-term and long-term vision using Envision (Path to Future) module for an AchieveX-card based Advanced Social Productivity Platform (ASPP)—OneworldX, in accordance with an embodiment of the present invention. The Envision module, it helps individual to envision near future by knowing what would make your life more exciting and happy? or Where do you see yourself in 5 or 10 years from now (short-term and long-term vision) by uploading 1402 the pictures on Vision Board. System provides the recommendation on what are the potential projects, goals, and tasks are required to fulfill their vision. Based on user own evaluation or system provided recommendations people can create new or Link the existing AchieveX-card 1406 to achieve. In addition, user can upload 1408 their favorite inspirational leaders and quotes on Vision board. System provides the recommendation on what are the potential projects, goals, and tasks are required to fulfill their vision. Based on user evaluation or system provided recommendations people can create new or Link the existing AchieveX-card 1412 to achieve.

Referring again to FIG. 14, the entity user (like business, organization, and government) follows same process illustrated in to visualize their short-term and long-term vision using Envision (Path to Future) module. Based on entity user own evaluation or system provided recommendations employees can create new or Link the existing AchieveX-card to achieve.

FIG. 15 is an illustration of exemplary flow 1500 chart depicting the process for TransformLife 360 system for focusing what really matter for both individual and entity (like business, organization, and government) for the complete transformation for an AchieveX-card based Advanced Social Productivity Platform (ASPP)—OneworldX, in accordance with an embodiment of the present invention. The TransformLife 360 is part of Explore module 110, based user interest it filters and categories the publicly shared AchieveX-card cards as well as AchieveX-card Templates in four ways:

1) MakeChange 1502, under this section of AchieveX cards and Templates, helps people to bring positive change in their personal, professional and social life. For entity user, it helps to bring positive change in the company or organizational culture.

2) GainStrength 1504, under this section of AchieveX cards and Templates, helps people to acquire necessary knowledge, education, and skills. For entity user, it helps employees to acquire necessary knowledge, training, and skills.

3) MoveForward 1506, under this section of AchieveX cards and Templates, drives innovation to power people, business, and organization.

4) KeepSustain 1508, under this section of AchieveX cards and Templates, encourages both people and entity to protect the Mother Nature and maintain peace for now and in the future. The above four components of the TransformLife 360 are intertwined and interdependent.

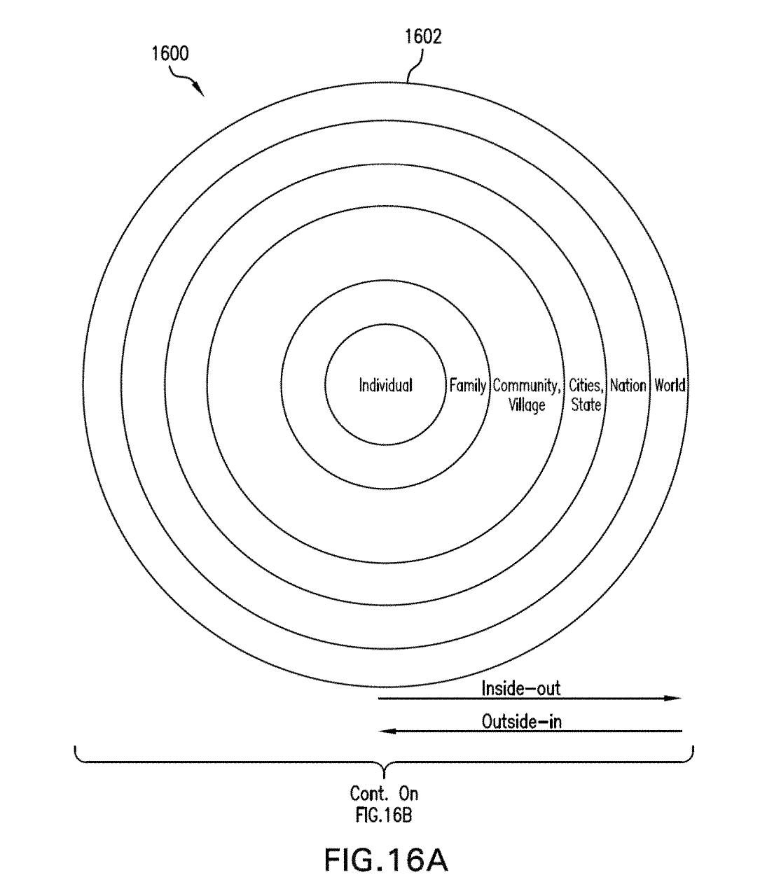

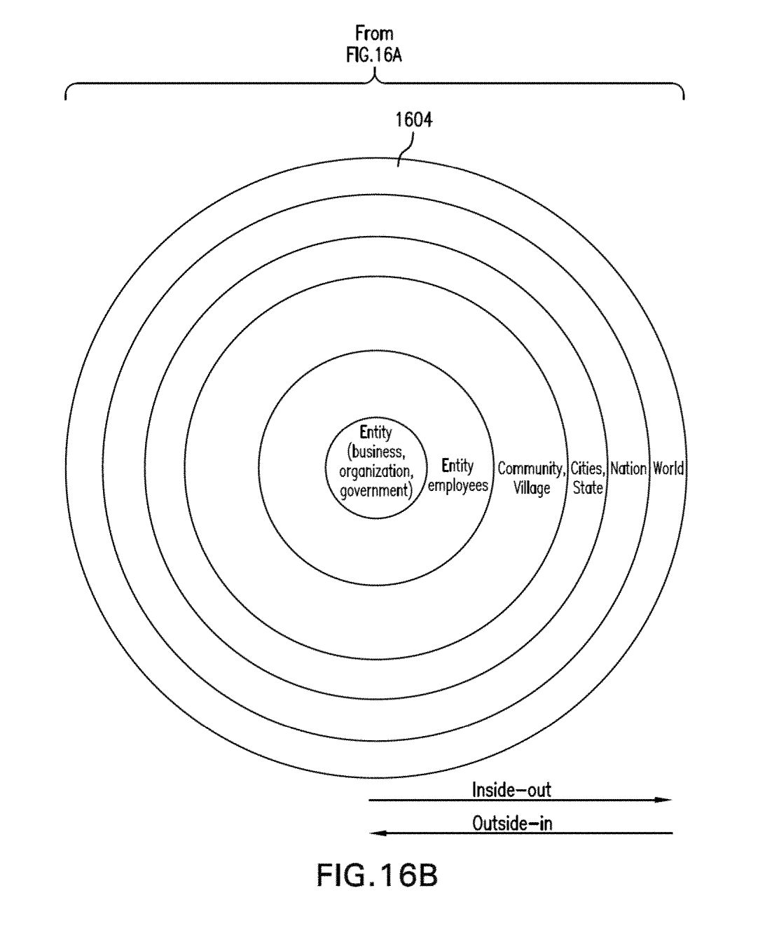

FIGS. 16A-16B is an illustration of 1600 socio-economic development and transformation from individual to world, entity (like business, organization, and government) to world for an AchieveX-card based Advanced Social Productivity Platform (ASPP)-OneworldX, in accordance with an embodiment of the present invention. The OneworldX platform build in a belief that the socio-economic development and transformation should start from an individual to world 1602, in a way that individual to family to community/village to cities/state to Nation to world. Similarly, socio-economic development and transformation should start from an entity (like business, organization, and government) to world 1604, in a way that entity to entity culture/employees to community/village to cities/state to Nation to world.

FIG. 17 is an illustration of architectural block diagram 1700 for building advanced user interface, Krish (Artificial General Intelligence—AGI), Digital Twin, VR/AR on top of cloud infrastructure for an AchieveX-card based Advanced Social Productivity Platform (ASPP)—OneworldX, in accordance with an embodiment of the present invention. There are six main building blocks:

1) USER INTERFACES 1712: There five ways for user to interact and experience with OneworldX platform: 1.1) Mobile Apps runs on iOS, Android, and Windows platform for all mobile users 1.2) Websites for Desktop and Laptop users 1.3) AR/VR wearable device that user can use to visualize their Vision and achievement. 1.4) Digital Twin, is the virtual representation of the individual or entity. This is a future way of interacting to know more yourself Krish (AGI)—Achievement Assistance is part of (embedded) all above user interfaces, where user simply can say “Krish” and ask question or ask to perform task.

2) ARTIFICIAL INTELLIGENT (AI) 1710: Building Machine and Deep Learning Models by training and analyzing trillions of data in Big data block 1704. These trained models are used by Krish (AGI), Digital twin and VR/AR. There are three main things in this block: 2.1) Krish (AGI)—Achievement Assistance, trained to perform so many things. Notably: voice enabled interaction, automate the recurring task, answering to user question, smart search, recommendation, smart analytics, summarization, and smart Ads. 2.2) Digital Twin, is the virtual representation of the individual/entity user which build on top of the current and history of leaning patterns to provide Personal Assistance. 2.3) Argument Reality (AR)/Virtual Reality (VR) graphics and data models build on top of the user data as well as leveraging Big data block 1704.

3) SEMANTIC SEARCH ENGINE 1708: Semantic Search Engine, improves search accuracy by understanding the user's intent and the contextual meaning to generate more relevant results or what is really matter. It uses the Graph database structure as well as Linked data for semantic queries.

4) DATA ENHANCEMENT 1706: interpret, analyze, and learn from vast and growing stores of data using machine learning and deep learning and apply the results to enhance the user experience. This block consists of three key components: 4.1) Graph database based on social interaction, interest, relationships and enrich interest graph by leveraging number of encourages and ratings. 4.2) Models and Patterns that helps to make right predictions. 4.3) Linked data is published structured data in web and Krish leverage some of open linked data set such as DBpedia, GeoNames, FOAF, UMBEL.

5) BIG DATA 1704: extract, store, and maintain the external as well as local data. It provides the knowledge needed for Krish (AGI) to continue to learn and evolve.

5) CLOUD PLATFORM 1704: build on distributed server hardware, software defined networking, and software defined service. There four main things in this block: 5.1) Integration Hub/External Interfaces provides ability connect with external systems and data sources 5.2) IOT (internet of things) provides ability to connect machines and devices. 5.3) Blockchain technology used to secure, distribute the cryptocurrency of OneworldX that is “OneXcoin”. 5.4) End-to-End security in place to secure the data in rest as well as data in motion.

In one embodiment of the present invention, not shown in the drawings, Focus Module has three components: 1) Personal (Me) component sections filters and list AchieveX-cards that are relevant to personal life. 2) Professional (My Company) component sections filters and list AchieveX-cards that are relevant to professional life. 3) Public (My Country) component sections filters and list AchieveX-cards that are relevant to public life or social life: country, village, and city.

In one embodiment of the present invention, not shown in the drawings, there are three more modules part of tracking and managing the AchieveX-cards: 1) BlackBox Module provides the list of potential issues that need user attention by using Krish (AGI) recommendation system algorithms. 2) BlueBox Module provides set of recommended activities that keep the user motivated and continue to focus on by using the Krish (AGI) recommendation system algorithms. 3) GreenBox Module provides the status and statistical report on AchieveX-card to keep the user up-to-date.

In one embodiment of the present invention, not shown in the drawings, Knowledge Module, user can share their knowledge and expertise by creating blogs, wiki, and uploading articles and books. All internal and external contents are organized by using TransformLife 360 system in FIG. 10 helps the user to focus on what really matter for the complete life transformation.

In one embodiment of the present invention, not shown in the drawings, Document Module, it is acting as a document repository, where user can store the documents are more specific to their AchieveX-card activities, and they can share them with team members or others.

In one embodiment of the present invention, not shown in the drawings, MessengerOne system, facilitates the collaboration more easily while user is resolving the problems or getting assistance from people, business, and organization. The communication method includes text message, voice message, video conference, and more. The MessengerOne is closely integrated with main OneworldX platform to get real-time users contact information as well as their AchieveX-card information although it runs outside of the main OneworldX platform.

What is claimed:

1. A method for improving a project comprising:
registering a user in a database;
making at least one inquiry about a first topic;
creating at least one personal card for the at least one inquiry with information regarding the first topic;
linking the at least one personal card to at least one public card;
exploring the at least one public card for content matching the topic of the at least one personal card;
using matching content from the at least one public card as assistance for the first topic, by creating an action plan with steps or items linked to the matching content on the personal card;
executing at least one of the steps or items of the action plan;
verifying execution of the at least one the steps or items of the action plan on the personal card;
executing remaining steps or items of the action plan;
verifying execution of the remaining steps of items of the action plan; and
completing the personal card with verification information on the personal card.

2. The method of claim 1, the exploring step further includes a discussion step.

3. The method of claim 2, wherein the discussion step further comprises a chat.

4. The method of claim 1, wherein the exploring step further includes a crowdifying step.

5. The method of claim 1, further comprising motivation and advice supplied from an original owner of a public card.

6. The method of claim 1, wherein the topic is selected from a group comprising tasks, events, goals, projects, or any combination thereof.

7. The method of claim, wherein the card is a paper card.

8. The method of claim 1, wherein the card is a digital file.

9. The method of claim 1, wherein the inquiry includes questioning the spirit of the first topic, the future of the first topic, the plan of the first topic, the community of the first topic or any combination thereof.

10. The method of claim 1, wherein the user is an individual or entity.

11. The method of claim 10, wherein the entity is a business or an NGO.

12. The method of claim 1, further comprising publishing the private card as a second public card.

13. The method of claim 12, wherein the second public card is transformed into a template for future cards.

14. The method of claim 1, further comprising making a new inquiry on the first topic.

15. The method of claim 1, further comprising making a new inquiry on a second topic.

16. The method of claim 1, further comprising a celebration.

17. The method of claim 1, wherein the personal card has is linked to at least one sub card.

18. The method of claim 16, wherein the at least one sub card contains a step and a link to a third public card.

19. A card for social productivity comprising:
at least five concentric and coplanar circular levels;
wherein each of the at least 5 circular levels comprises a category starting with the letter “E”;
wherein each category contains a query regarding a topic.
